(19) United States
(12) Patent Application Publication
(10) Pub. No.: US 2015/0242945 A1
(43) Pub. Date: Aug. 27, 2015

(54) SYSTEM AND METHOD FOR PROVIDING BIDDING SERVICE

(71) Applicants: Gyu Sung PARK, Changwon-si (KR); Jun Hyeong PARK, Changwon-si (KR)

(72) Inventors: Gyu Sung PARK, Changwon-si (KR); Jun Hyeong PARK, Changwon-si (KR)

(21) Appl. No.: 14/632,784

(22) Filed: Feb. 26, 2015

(30) Foreign Application Priority Data
Feb. 27, 2014 (KR) 10-2014-0023166

(51) Int. Cl. G06Q 30/08; G06Q 30/06

(52) U.S. Cl. CPC G06Q 30/08; G06Q 30/0611

(57) ABSTRACT

The present invention disclosed herein relates to a system and method for providing a bidding service. A bidding service providing system according to an embodiment of the present invention may include a bidding condition determination unit configured to determine a maximum number of bidders and a bidding price on a basis of an equivalent value of a bid subject, a successful bidder selection unit configured to select a predetermined number of successful bidders from among bidders, and a repayment processing unit configured to set a credit-debt relation between the successful bidders and failed bidders and perform a process for repayment of debt to the failed bidders by the successful bidders.

### CROSS-REFERENCE TO RELATED APPLICATIONS

This U.S. non-provisional patent application claims priority under 35 U.S.C. §119 of Korean Patent Application No. 10-2014-0023166, filed on Feb. 27, 2014, the entire contents of which are hereby incorporated by reference.

### BACKGROUND OF THE INVENTION

The present invention disclosed herein relates to a system and method for providing a bidding service.

As information technology (IT) is developed and the Internet is more widely used, existing offline events are also performed in an online environment. For example, some online service providers provide products or services to consumers using a competitive-bidding-based method such as auction.

Competitive bidding represents a bidding method in which a successful bidder is selected from among a plurality of bidders on the basis of a certain selection criterion so that a contract is established. Court auction or a contract for work is typically established through the competitive bidding.

In general, if bidding is opened, participants in the bidding submit bidding documents to make a bid, and a person placing an order selects a successful bidder who has proposed the most advantageous condition from among the bidders.

For example, a court that sells real estate selects one of bidders who has proposed the highest price to auction off an item to be sold, and a project entity of construction work selects one of bidders who has proposed the lowest contract price to establish a contract for work.

As described above, according to a typical bidding method, bidders propose their desired prices, and one of the bidders who has proposed the most advantageous condition to a person placing an order is selected as a successful bidder.

### SUMMARY OF THE INVENTION

The present invention provides a bidding service providing system and method in which a bid is performed in a novel manner to select a successful bidder and compensate a failed bidder for bidding failure.

Embodiments of the present invention provide bidding service providing systems including a bidding condition determination unit configured to determine a maximum number of bidders and a bidding price on the basis of an equivalent value of a bid subject, a successful bidder selection unit configured to select a predetermined number of successful bidders from among the bidders, and a repayment processing unit configured to set a credit-debt relation between the successful bidders and failed bidders according to a successful bid and perform a process for repayment of debt to the failed bidders by the successful bidders.

In some embodiments, the bidding condition determination unit may receive the maximum number of the bidders and then may determine the bidding price by dividing the equivalent value of the bid subject by the maximum number of the bidders.

In other embodiments, the bidding condition determination unit may receive the bidding price and then may determine the maximum number of the bidders by dividing the equivalent value of the bid subject by the bidding price. In still other embodiments, the bidding condition determination unit may assign the same bidding price to the bidders.

In even other embodiments, the bid subject may include at least one of a movable asset, real estate, and a right.

In yet other embodiments, the successful bidder selection unit may arbitrarily select the predetermined number of the successful bidders from among the bidders.

In further embodiments, the successful bidder selection unit may select the successful bidders using public information that is not known at a time of making a bid but is known when bidding is completed.

In still further embodiments, the repayment processing unit may receive, from the bidders, consent to generation of credit and debt between the successful bidders and the failed bidders according to the successful bid.

In even further embodiments, the repayment processing unit may collect information on the successful bidders, information on the failed bidders, and information on an amount of money to be repaid by the successful bidders for the failed bidders.

In yet further embodiments, the amount of money to be repaid by the successful bidders for the failed bidders may be calculated on the basis of the bidding price.

In much further embodiments, the repayment processing unit may further collect information on a method of repayment to the failed bidders by the successful bidders.

In still much further embodiments, the information on the method of the repayment may include at least one of a number of times of the repayment, a period required for the repayment, and a repayment means.

In even much further embodiments, the repayment means may include at least one of cash, securities, and near money able to be used like cash under predetermined conditions.

In yet much further embodiments, the repayment processing unit may request, on the basis of the collected information, execution of the repayment from a financial institution.

In yet still much further embodiments, the repayment processing unit may receive, from the failed bidders, an application for donation of money to be refunded, and may perform a process for donating the money when the successful bidders repay the debt.

In other embodiments of the present invention, methods for providing, to bidders, a bidding service by a bidding service providing system including a bidding condition determination unit, a successful bidder selection unit, and a repayment processing unit include determining, by the bidding condition determination unit, a maximum number of the bidders and a bidding price on the basis of an equivalent value of a bid subject, selecting, by the successful bidder selection unit, a predetermined number of successful bidders from among the bidders, setting, by the repayment processing unit, a credit-debt relation between the successful bidders and failed bidders according to a successful bid, and performing, by the repayment processing unit, a process for repayment of debt to the failed bidders by the successful bidders.

In some embodiments, the determining the maximum number of the bidders and the bidding price on the basis of the equivalent value of the bid subject may include receiving the maximum number of the bidders, and determining the bidding price by dividing the equivalent value of the bid subject by the maximum number of the bidders.

In other embodiments, the determining the maximum number of the bidders and the bidding price on the basis of the equivalent value of the bid subject may include receiving the bidding price, and determining the maximum number of the bidders by dividing the equivalent value of the bid subject by the bidding price.

In still other embodiments, the determining the maximum number of the bidders and the bidding price on the basis of the equivalent value of the bid subject may include assigning the same bidding price to the bidders.

In even other embodiments, the bid subject may include at least one of a movable asset, real estate, and a right.

In yet other embodiments, the selecting the successful bidders may include arbitrarily selecting the predetermined number of the successful bidders from among the bidders.

In further embodiments, the selecting the successful bidders may include selecting the successful bidders using public information that is not known at a time of making a bid but is known when bidding is completed.

In still further embodiments, the setting the credit-debt relation between the successful bidders and the failed bidders may include receiving, from the bidders, consent to generation of credit and debt between the successful bidders and the failed bidders according to the successful bid.

In even further embodiments, the performing the process for the repayment of the debt to the failed bidders by the successful bidders may include collecting information on the successful bidders, information on the failed bidders, and information on an amount of money to be repaid by the successful bidders for the failed bidders.

In yet further embodiments, the amount of money to be repaid by the successful bidders for the failed bidders may be calculated on the basis of the bidding price.

In much further embodiments, the performing the process for the repayment of the debt to the failed bidders by the successful bidders may include collecting information on a method of the repayment to the failed bidders by the successful bidders.

In still much further embodiments, the information on the method of the repayment may include at least one of a number of times of the repayment, a period required for the repayment, and a repayment means.

In even much further embodiments, the repayment means may include at least one of cash, securities, and near money able to be used like cash under predetermined conditions.

In yet much further embodiments, the performing the process for the repayment of the debt to the failed bidders by the successful bidders may include requesting, on the basis of the collected information, execution of the repayment from a financial institution.

In yet still much further embodiments, the performing the process for the repayment of the debt to the failed bidders by the successful bidders may include receiving, from the failed bidders, an application for donation of money to be refunded, and performing a process for donating the money when the successful bidders repay the debt.

In still other embodiments of the present invention, computer-readable recording media record a program for performing, in a computer, a bidding service providing method.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is an exemplary diagram illustrating a connection relation between a bidding service providing system and bidders according to an embodiment of the present invention;

FIG. 2 is an exemplary block diagram illustrating the bidding service providing system according to an embodiment of the present invention;

FIG. 3 is an exemplary diagram illustrating a bidding process according to an embodiment of the present invention;

FIG. 4 is an exemplary diagram illustrating settlement by a successful bidder according to an embodiment of the present invention;

FIG. 5 is an exemplary diagram illustrating a process of repayment to failed bidders by a successful bidder according to an embodiment of the present invention;

FIG. 6 is an exemplary flowchart illustrating a bidding service providing method according to an embodiment of the present invention;

FIG. 7 is an exemplary flowchart illustrating a bidding condition determination process according to an embodiment of the present invention;

FIG. 8 is an exemplary flowchart illustrating a bidding condition determination process according to another embodiment of the present invention;

FIG. 9 is an exemplary flowchart illustrating a process of repayment to failed bidders by a successful bidder according to an embodiment of the present invention; and

FIG. 10 is an exemplary flowchart illustrating a process of repayment to failed bidders by a successful bidder according to another embodiment of the present invention.

### DETAILED DESCRIPTION OF PREFERRED EMBODIMENTS

Advantages and features of the present invention and methods for achieving them will be clarified through the description of embodiments provided below with reference to the accompanying drawings. The present invention may, however, be embodied in different forms and should not be construed as being limited to the embodiments described below. Rather, these embodiments are provided so that this disclosure will be thorough and complete, and will fully convey the scope of the present invention to those skilled in the art, and the present invention is defined by the scope of claims.

The terms (including technical or scientific terms) used herein have the meanings generally accepted in the art, unless otherwise defined. The terms defined in general dictionaries may be interpreted as having the same meanings as those of the terms used in the related art and/or the present disclosure, and should not be interpreted in an idealized or overly formal sense unless otherwise defined explicitly.

The terminology used herein is not for delimiting the embodiments of the present invention but for describing the embodiments of the present invention. The terms of a singular form may include plural forms unless otherwise specified. The meaning of “include,” “comprise,” “including,” or “comprising,” specifies a composition, an ingredient, a component, a step, an operation and/or an element but does not exclude other compositions, ingredients, components, steps, operations and/or elements. The term “and/or” used herein indicates each of listed elements or various combinations thereof.

The term “. . . unit”, “. . . block”, “. . . module” or the like used herein may represent a unit for processing at least one function or operation. For example, such a term may represent a hardware element such as FPGA or ASIC. However, the term “. . . unit”, “. . . block”, “. . . module” or the like is not limited to software or hardware. The “. . . unit”, “. . . block”, “. . . module” or the like may be configured to be present in an addressable storage medium or may be configured to operate one or more processors.

Therefore, for example, the “. . . unit”, “. . . block”, “. . . module” or the like includes elements such as software elements, object-oriented software elements, class elements, and task elements, and processes, functions, attributes, procedures, subroutines, program code segments, drivers, firmware, microcodes, circuits, data, databases, data structures, tables, arrays, and variables. The elements and functions provided in the “. . . unit”, “. . . block”, “. . . module” or the like may be combined with each other to provide a smaller number of elements and the “. . . unit”, “. . . block”, “. . . module” or the like, or may be divided to provide additional element and “. . . unit”, “. . . block”, “. . . module” or the like.

Hereinafter, embodiments of the present invention will be described in detail with reference to the accompanying drawings.

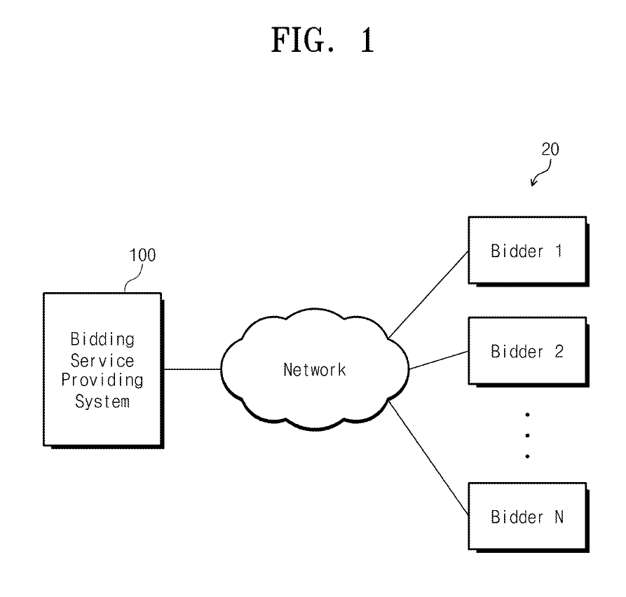

FIG. 1 is an exemplary diagram illustrating a connection relation between a bidding service providing system 100 and a bidder 20 according to an embodiment of the present invention.

As illustrated in FIG. 1, the bidding service providing system 100 may be connected to the bidders 20 through a network. That is, the bidders 20 may access the bidding service providing system 100 via the network to participate in a bid.

The bidding service providing system 100 may provide terms or contacts for a bidding service to the bidders 20 through an online connection, and the bidders 20 may submit bidding documents to the bidding service providing system 100 through an online connection.

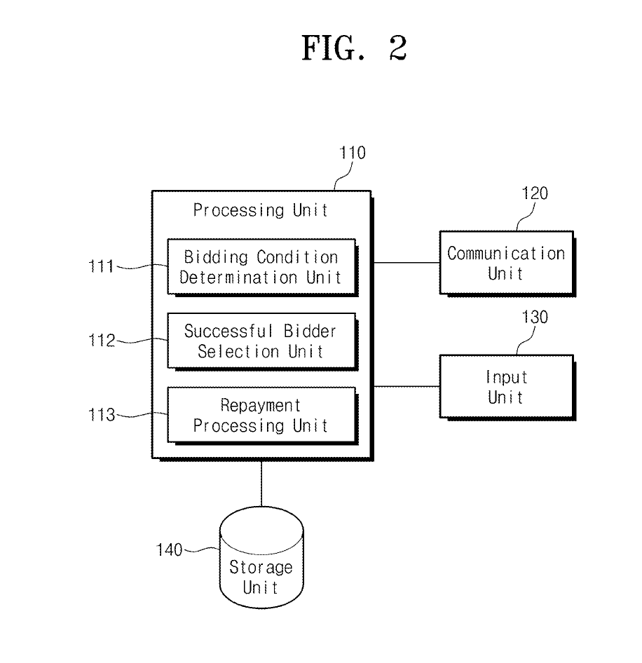

FIG. 2 is an exemplary block diagram illustrating the bidding service providing system 100 according to an embodiment of the present invention.

As illustrated in FIG. 2, the bidding service providing system 100 may include a processing unit 110, a communication unit 120, an input unit 130, and a storage unit 140.

The processing unit 110 which is a processor performs a process on a bidding service that will be described later. The processing unit 110 may include a bidding condition determination unit 111, a successful bidder selection unit 112, and a repayment processing unit 113.

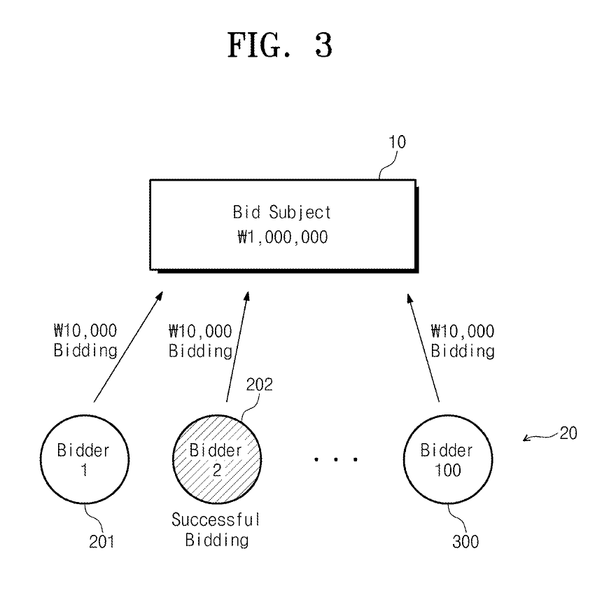

Specific processes or operations performed by the bidding condition determination unit 111, the successful bidder selection unit 112, and the repayment processing unit 113 will be described with reference to FIGS. 3 to 11.

The communication unit 130 which is a network adapter transmits/receives data so that the bidding service providing system 100 proceeds with a bidding process together with the bidders 20 through the network.

The input unit 13 which is an input device such as a keyboard or a mouse may allow data or a command to be input to the bidding service providing system 100.

The storage unit 140 which is a storage device including an HDD, an SSD or a memory stores data about a bid, for example, bidding conditions, bidder information, and contents of a contract defining a credit-debt relation between a successful bidder and a failed bidder.

According to an embodiment of the present invention, the bidding condition determination unit 111 may determine a maximum number of bidders and a bidding price on the basis of an equivalent value of a bid subject.

FIG. 3 is an exemplary diagram illustrating a bidding process according to an embodiment of the present invention.

Referring to FIG. 3, the bidding service providing system 100 may present a bid subject 10 with a certain equivalent value to collect bidders.

According to an embodiment of the present invention, the bid subject 10 includes any assignable thing. For example, the bid subject 10 may include not only movable assets such as a TV and real estate such as an apartment but also a fund such as a business fund and a right such as a business right.

The bid subject 10 has a certain equivalent value, and the maximum number of bidders and the bidding price for the bid subject 10 are determined on the basis of the equivalent value.

According to an embodiment of the present invention, the bidding condition determination unit 111 may receive the maximum number of bidders, and then may determine the bidding price by dividing the equivalent value of the bid subject 10 by the maximum number of bidders.

For example, as illustrated in FIG. 3, in the case where the equivalent value of the bid subject 10 is determined to be one million won and the maximum number of bidders is determined to be 100, the bidding condition determination unit 111 may determine the bidding price as 10 thousand won by dividing one million by 100.

The maximum number of bidders may be determined and input by an operator of the bidding service providing system 100, but an entity for determining and inputting the maximum number of bidders is not limited thereto.

According to another embodiment of the present invention, the bidding condition determination unit 111 may receive the bidding price, and then may determine the maximum number of bidders by dividing the equivalent value of the bid subject 10 by the bidding price.

For example, as illustrated in FIG. 3, in the case where the equivalent value of the bid subject 10 is determined to be one million won and the bidding prices is determined to be 10 thousand won, the bidding condition determination unit 111 may determine the maximum number of bidders as 100 by dividing one million by 10 thousand.

The bidding price may be determined and input by the operator of the bidding service providing system 100, but an entity for determining and inputting the bidding price is not limited thereto.

According to an embodiment of the present invention, the bidding condition determination unit 111 may assign the same bidding price to the bidders 20.

For example, as illustrated in FIG. 3, the bidding condition determination unit 111 may equally assign the determined bidding price to the bidders 20, the number of which corresponds to the determined maximum number of bidders. In this respect, an embodiment of the present invention may be different from a typical competitive-bidding-based method.

According to an embodiment of the present invention, the operator may appropriately adjust the maximum number of bidders according to the equivalent value of the bid subject 10 so as to reduce a burden of the bidding price on the bidders 20.

FIG. 3 illustrates that 100 bidders 20 bid for the bid subject 10 while proposing a bidding fee of 10 thousand won.

The successful bidder selection unit 112 may select a predetermined number of successful bidders from among the bidders 20.

According to an embodiment of the present invention, the successful bidder selection unit 112 may arbitrarily select a predetermined number of successful bidders from among the bidders 20. That is, according to an embodiment of the present invention, a successful bidder is arbitrarily selected instead of selecting, as a successful bidder, a person who has proposed the most advantageous condition to a person placing an order among the bidders 20. In this respect, an embodiment of the present invention may be different from a typical competitive-bidding-based method.

According to another embodiment of the present invention, the successful bidder selection unit 112 may select the successful bidder using public information that is not known at the time of making a bid but is known when bidding is completed.

For example, the successful bidder selection unit 112 may select the successful bidder using information that is not known at the time of making a bid but is known when bidding is completed, such as a result of lottery drawing (e.g., a lottery number) performed after the completion of bidding or a composite stock price index at the date after the completion of bidding.

As described above, according to an embodiment of the present invention, public information that is not known at the time of making a bid but is known when bidding is completed is used, thereby providing credibility to a successful bidder selection process.

FIG. 3 illustrates that one bidder, i.e., a second bidder 202, is selected as a successful bidder for the bid subject 10, but the number of successful bidders is not limited thereto and may be two or more.

The repayment processing unit 113 may set a credit-debt relation between a successful bidder and a failed bidder, and may perform a process so that the successful bidder repays a debt to the failed bidder.

According to an embodiment of the present invention, the successful bidder may legitimately take over the bid subject 10, but owes a certain amount of a debt to the other bidders, i.e., failed bidders. That is, according to an embodiment of the present invention, a successful bid may establish a certain credit-debt relation between a successful bidder and a failed bidder.

To this end, the repayment processing unit 113 may receive, from the bidders 20, consent to generation of credit and debt between a successful bidder and a failed bidder, when the bidders 20 make a bid.

As a result, as illustrated in FIG. 3, the second bidder 202 who has made a successful bid for the bid subject 10 owes a certain amount of debt to other bidders, i.e., a first bidder and the third to 100th bidders.

According to an embodiment of the present invention, the repayment processing unit 113 may collect information on the successful bidder, information on the failed bidders, and information on an amount of money to be repaid by the successful bidder for the failed bidders, so that the successful bidder repays a debt to the failed bidders.

For example, the repayment processing unit 113 may collect information for specifying the successful bidder and the failed bidders, such as names, addresses and resident registration numbers of the successful bidder and the failed bidders, and information on an amount of money to be repaid by the successful bidder for the failed bidders. The collected information may be stored in the storage unit 140 by consent of information providers, and then may be used for a process for repaying a debt.

According to an embodiment of the present invention, the amount of money to be repaid by the successful bidder for the failed bidders may be calculated on the basis of the bidding price.

For example, the amount of money to be repaid may be the same as the bidding fee paid by each bidder to participate in a bid. In this case, the bidders may be paid back with the bidding fee even if the bidders fail in the bid, so that a burden of participating in the bid may be reduced for the bidders 20.

Furthermore, since the amount of money to be refunded to the failed bidders is borne by the successful bidder, a bid may be prevented from being speculative according to an embodiment of the present invention.

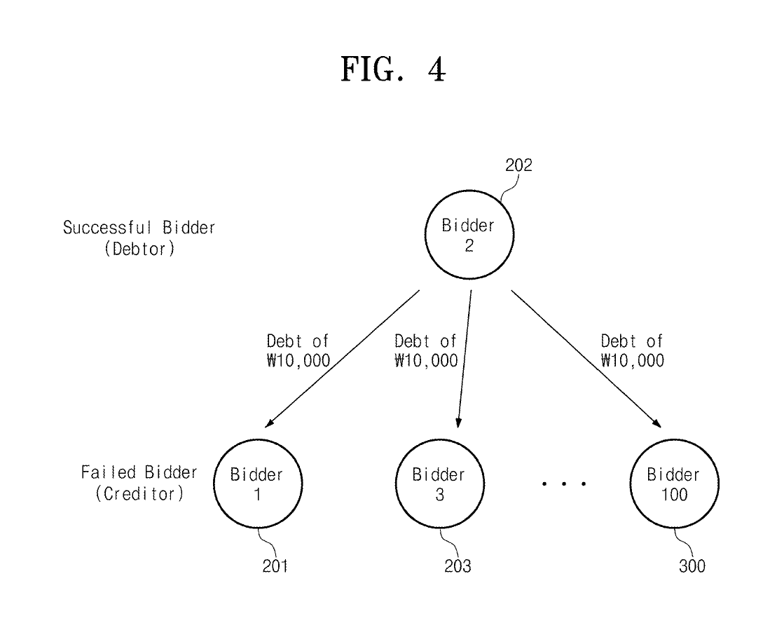

FIG. 4 is an exemplary diagram illustrating settlement by a successful bidder according to an embodiment of the present invention.

Referring to FIG. 4, since the second bidder 202 successfully bids for the bid subject 10, the second bidder 202 owes the bidding fee, i.e., 10 thousand won, to each of the first bidder 201 and the third to 100th bidders 203 to 300.

The repayment processing unit 113 may further collect information on a method of repayment to the failed bidders by the successful bidder.

According to an embodiment of the present invention, the information on the method of repayment may include at least one of the number of times of repayment, a period required for repayment, and a repayment means.

For example, if the number of times of repayment is one, the successful bidder may repay a debt to the failed bidders in a lump sum, or, if the number of times of repayment is two or more, the successful bidder may repay a debt to the failed bidders by installment.

Furthermore, the period required for repayment may be designated so that a date at which the successful bidder repays a debt to the failed bidders may be adjusted.

For example, provided that the second bidder 202 illustrated in FIG. 4 plans to save 10 thousand won every month to repay a debt to the failed bidders in a lump sum 99 months later, and receives consent on this plan from the bidders 20 in advance when they make a bid, the second bidder 202 who has successfully bid for the bid subject 10 receives substantially the same benefit as purchasing the bid subject 10 on a 99-month interest-free installment plan by virtue of burden sharing of the failed bidders.

The repayment means may be designated as the information on the method of repayment to the failed bidders by the successful bidder.

According to an embodiment of the present invention, the repayment means may include at least one of cash, securities, and near money. Herein, the near money represents a payment means that is able to be used like cash under predetermined conditions, such as reward points of credit cards.

Therefore, if the successful bidder and the failed bidders agree on repayment by near money, the successful bidder may repay a debt to the failed bidders using the near money.

According to an embodiment of the present invention, the repayment to the failed bidders by the successful bidder may be executed through a financial institution.

To this end, the repayment processing unit 113 may request the execution of the repayment from a financial institution such as a bank or a credit card company on the basis of the collected information.

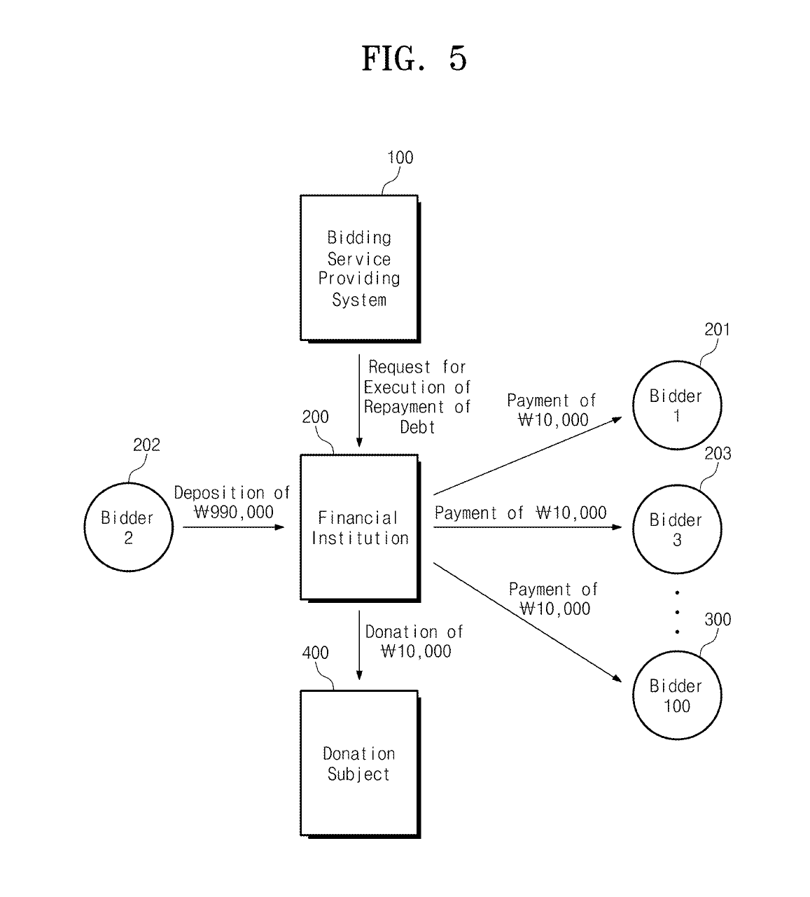

FIG. 5 is an exemplary diagram illustrating a process of repayment to the failed bidders by the successful bidder according to an embodiment of the present invention.

Referring to FIG. 5, when the second bidder 202 is selected as a successful bidder, the bidding service providing system 100 may request a financial institution 200 to execute the repayment to the failed bidders, i.e., the first bidder 201 and the third to 100th bidders 203 to 300, by the second bidder 202, on the basis of the information collected for the repayment.

Such a request for the execution of the repayment may be performed in such a manner that the bidding service providing system 100 provides the information collected for the repayment to the financial institution 200 through the network and requests a transaction for paying a debt to the failed bidders through a predetermined repayment method.

For example, as described above, in the case where the successful bidder receives consent from the bidders 20 to deposit 10 thousand won every month over 99 months and pay 10 thousand won to each failed bidder 99 months later, the bidding service providing system 100 may send, on the basis of such information on repayment of a debt, a request for a transaction for receiving 10 thousand won from a credit card payment account of the second bidder 202 every month and transferring 10 thousand won to a credit card payment account of each of the first bidder 201 and the third to 100th bidders 203 to 300 99 months later.

According to another embodiment of the present invention, the repayment processing unit 113 may receive, from the failed bidder, an application for donation of money to be refunded, and may perform a process of donating the money when the successful bidder repays a debt.

For example, referring to FIG. 5, if the third bidder 203, one of the failed bidders, applies for donation of money to be refunded to a donation subject 400, the bidding service providing system 100 may request the financial institution 200 to donate 10 thousand won to the donation subject 400.

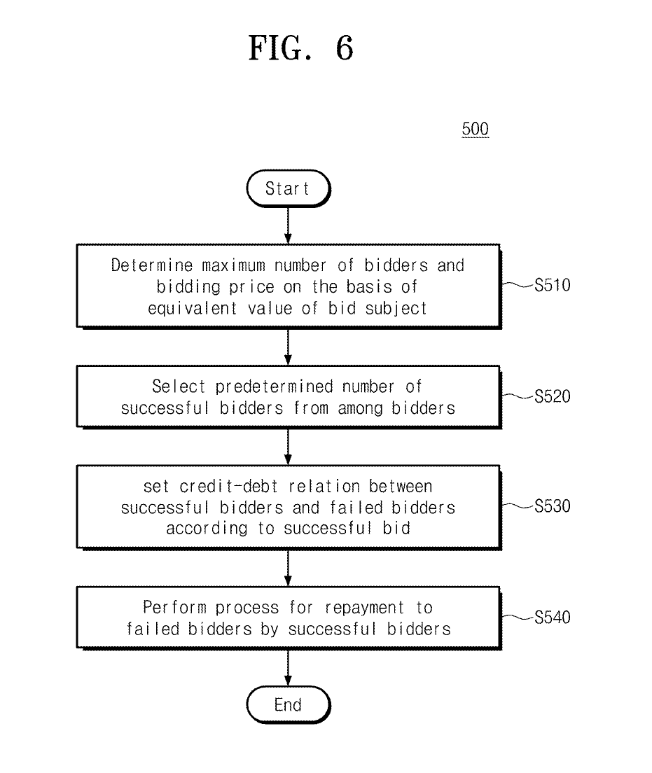

FIG. 6 is an exemplary flowchart illustrating a bidding service providing method 500 according to an embodiment of the present invention.

The bidding service providing method 500 may be performed by the above-mentioned bidding service providing system 100 according to an embodiment of the present invention.

As illustrated in FIG. 6, the bidding service providing method 500 may include determining, by the bidding condition determination unit 111, the maximum number of bidders and the bidding price on the basis of the equivalent value of the bid subject 10 (S510), selecting, by the successful bidder selection unit 112, a predetermined number of successful bidders from among the bidders 20 (S520), setting a credit-debt relation between the successful bidders and the failed bidders (S530), and performing, by the repayment processing unit 113, a process for repayment to the failed bidders by the successful bidders.

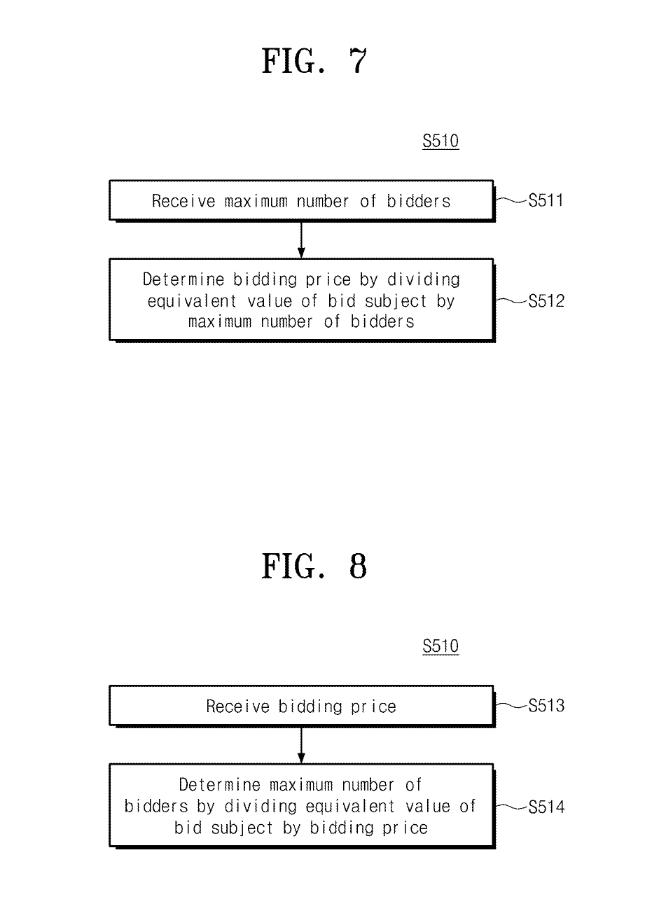

FIG. 7 is an exemplary flowchart illustrating a bidding condition determination process 510 according to an embodiment of the present invention.

As illustrated in FIG. 7, according to an embodiment of the present invention, the bidding condition determination process 510 may include determining the maximum number of bidders and the bidding price on the basis of the equivalent value of the bid subject 10 (S510), receiving the maximum number of bidders (S511), and determining the bidding prices by dividing the equivalent value of the bid subject 10 by the maximum number of bidders (S512).

FIG. 8 is an exemplary flowchart illustrating a bidding condition determination process 510 according to another embodiment of the present invention.

As illustrated in FIG. 8, according to another embodiment of the present invention, the bidding condition determination process 510 may include determining the maximum number of bidders and the bidding price on the basis of the equivalent value of the bid subject 10 (S510), receiving the bidding price (S513), and determining the maximum number of bidders by dividing the equivalent value of the bid subject 10 by the bidding price (S514).

According to an embodiment of the present invention, the determining the maximum number of bidders and the bidding price on the basis of the equivalent value of the bid subject 10 (S510) may include assigning the same bidding price to the bidders 20.

According to an embodiment of the present invention, the bid subject 10 may include at least one of a movable asset, real estate, a fund and a right, but may include any assignable thing without being limited thereto.

According to an embodiment of the present invention, the selecting the successful bidders (S520) may include arbitrarily selecting a predetermined number of successful bidders from among the bidders 20. Here, the number of bidders selected as the successful bidders may be one or more.

According to another embodiment of the present invention, the selecting the successful bidders (S520) may include selecting the successful bidders using public information that is not known at the time of making a bid but is known when bidding is completed.

For example, the public information used to select the successful bidders may be a winning lottery number announced after the completion of bidding, a composite stock price index at the date after the completion of bidding, or the like.

According to an embodiment of the present invention, the setting the credit-debt relation between the successful bidders and the failed bidders (S530) may include receiving, from the bidders 20, consent to generation of credit and debt between the successful bidders and the failed bidders according to a successful bid. The consent to the generation of credit and debt may be received from the bidders 20 when they make a bid, but a time for receiving the consent from the bidders 20 is not limited thereto.

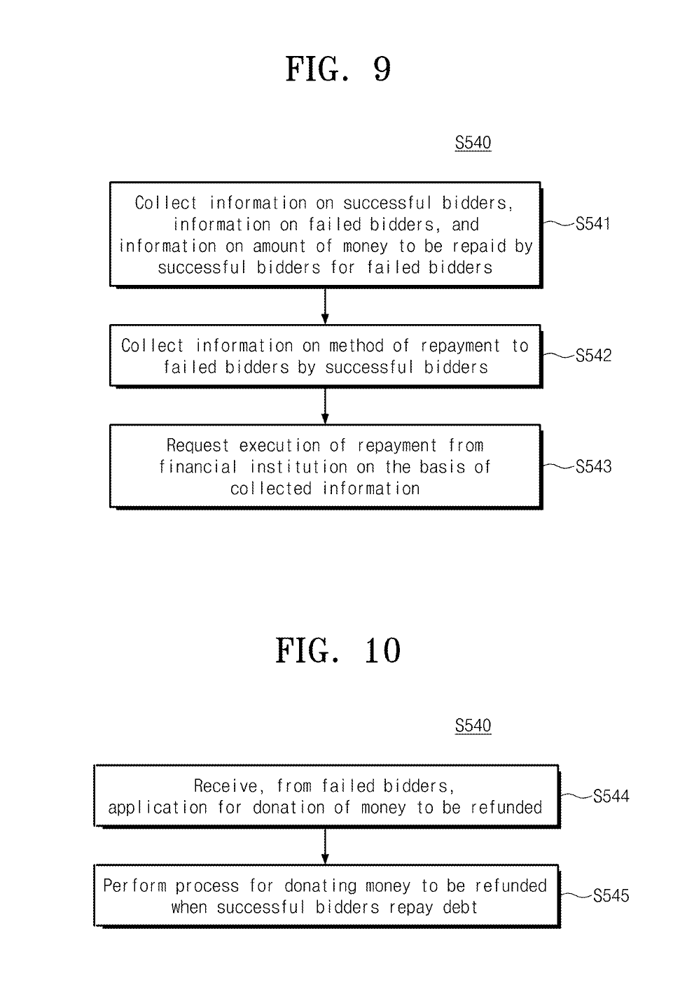

FIG. 9 is an exemplary flowchart illustrating a process 540 of repayment to the failed bidders by the successful bidders according to an embodiment of the present invention.

As illustrated in FIG. 9, the process 540 of repayment to the failed bidders by the successful bidders may include collecting information on the successful bidders, information on the failed bidders, and information on an amount of money to be repaid by the successful bidders for the failed bidders (S541). That is, in this operation, basic information on a creditor, a debtor and an amount of debt is collected.

According to an embodiment of the present invention, the amount of money to be repaid by the successful bidders for the failed bidders may be calculated on the basis of the bidding price. For example, the amount of money to be repaid by the successful bidders for the failed bidders may be equal to the bidding price, but may be smaller or larger than the bidding price according to embodiments of the present invention.

According to another embodiment of the present invention, the process 540 of repayment to the failed bidders by the successful bidders may further include collecting information on a method of repayment to the failed bidders by the successful bidders (S542).

Here, the information on the method of repayment may include at least one of the number of times of repayment, a period of time required for repayment, and a repayment means.

The repayment means may include at least one of cash, securities, and near money able to be used like cash under predetermined conditions.

The process 540 of repayment to the failed bidders by the successful bidders may further include requesting, on the basis of the collected information, execution of the repayment from the financial institution 200 (S543).

FIG. 10 is an exemplary flowchart illustrating a process 540 of repayment to the failed bidders by the successful bidders according to another embodiment of the present invention.

As illustrated in FIG. 10, according to another embodiment of the present invention, the process 540 of repayment to the failed bidders by the successful bidders may include receiving, from the failed bidders, an application for donation of money to be refunded (S544) and performing a process for donating the money to be refunded when the successful bidders repay a debt (S545).

That is, the failed bidders may donate the money to be refunded to the donation subject 400, and the bidding service providing system 100 may allow the money to be transferred to the donation subject 400 through the financial institution 200.

The bidding service providing method 500 may be implemented as a program to be executed by a computer, and may be stored in a computer-readable recording medium. The computer-readable recording medium includes any type of a storage device for storing data readably by a computer system. The computer-readable recording medium includes a ROM, a RAM, a CD-ROM, a magnetic tape, a floppy disk, and an optical data storage device.

According to an embodiment of the present invention, the burden of debt of the successful bidder due to taking over of the bid subject may be reduced by virtue of burden sharing of the failed bidders.

According to an embodiment of the present invention, the failed bidders receive compensation for bidding failure from the successful bidder so that the burden of participating in the bid may be reduced and the bid may be prevented from being speculative.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A bidding service providing system comprising:
a bidding condition determination unit configured to determine a maximum number of bidders and a bidding price on a basis of an equivalent value of a bid subject;
a successful bidder selection unit configured to select a predetermined number of successful bidders from among the bidders; and
a repayment processing unit configured to set a credit-debt relation between the successful bidders and failed bidders according to a successful bid and perform a process for repayment of debt to the failed bidders by the successful bidders.

2. The bidding service providing system of claim 1, wherein the bidding condition determination unit receives the maximum number of the bidders and then determines the bidding price by dividing the equivalent value of the bid subject by the maximum number of the bidders.

3. The bidding service providing system of claim 1, wherein the bidding condition determination unit receives the bidding price and then determines the maximum number of the bidders by dividing the equivalent value of the bid subject by the bidding price.

4. The bidding service providing system of claim 1, wherein the bidding condition determination unit assigns the same bidding price to the bidders.

5. The bidding service providing system of claim 1, wherein the bid subject comprises at least one of a movable asset, real estate, and a right.

6. The bidding service providing system of claim 1, wherein the successful bidder selection unit arbitrarily selects the predetermined number of the successful bidders from among the bidders.

7. The bidding service providing system of claim 1, wherein the successful bidder selection unit selects the successful bidders using public information that is not known at a time of making a bid but is known when bidding is completed.

8. The bidding service providing system of claim 1, wherein the repayment processing unit receives, from the bidders, consent to generation of credit and debt between the successful bidders and the failed bidders according to the successful bid.

9. The bidding service providing system of claim 1, wherein the repayment processing unit collects information on the successful bidders, information on the failed bidders, and information on an amount of money to be repaid by the successful bidders for the failed bidders.

10. The bidding service providing system of claim 9, wherein the amount of money to be repaid by the successful bidders for the failed bidders is calculated on the basis of the bidding price.

11. The bidding service providing system of claim 9, wherein the repayment processing unit further collects information on a method of repayment to the failed bidders by the successful bidders.

12. The bidding service providing system of claim 11, wherein the information on the method of the repayment comprises at least one of a number of times of the repayment, a period required for the repayment, and a repayment means.

13. The bidding service providing system of claim 12, wherein the repayment means comprises at least one of cash, securities, and near money able to be used like cash under predetermined conditions.

14. The bidding service providing system of claim 9, wherein the repayment processing unit requests, on a basis of the collected information, execution of the repayment from a financial institution.

15. The bidding service providing system of claim 1, wherein the repayment processing unit receives, from the failed bidders, an application for donation of money to be refunded, and performs a process for donating the money when the successful bidders repay the debt.

16. A method for providing, to bidders, a bidding service by a bidding service providing system comprising a bidding condition determination unit, a successful bidder selection unit, and a repayment processing unit, the method comprising:
determining, by the bidding condition determination unit, a maximum number of the bidders and a bidding price on a basis of an equivalent value of a bid subject;
selecting, by the successful bidder selection unit, a predetermined number of successful bidders from among the bidders;
setting, by the repayment processing unit, a credit-debt relation between the successful bidders and failed bidders according to a successful bid; and
performing, by the repayment processing unit, a process for repayment of debt to the failed bidders by the successful bidders.

17. The method of claim 16, wherein the determining the maximum number of the bidders and the bidding price on the basis of the equivalent value of the bid subject comprises:
receiving the maximum number of the bidders; and
determining the bidding price by dividing the equivalent value of the bid subject by the maximum number of the bidders.

18. The method of claim 16, wherein the determining the maximum number of the bidders and the bidding price on the basis of the equivalent value of the bid subject comprises:
receiving the bidding price; and
determining the maximum number of the bidders by dividing the equivalent value of the bid subject by the bidding price.

19. The method of claim 16, wherein the determining the maximum number of the bidders and the bidding price on the basis of the equivalent value of the bid subject comprises assigning the same bidding price to the bidders.

20. The method of claim 16, wherein the bid subject comprises at least one of a movable asset, real estate, and a right.

21. The method of claim 16, wherein the selecting the successful bidders comprises arbitrarily selecting the predetermined number of the successful bidders from among the bidders.

22. The method of claim 16, wherein the selecting the successful bidders comprises selecting the successful bidders using public information that is not known at a time of making a bid but is known when bidding is completed.

23. The method of claim 16, wherein the setting the credit-debt relation between the successful bidders and the failed bidders comprises receiving, from the bidders, consent to generation of credit and debt between the successful bidders and the failed bidders according to the successful bid.

24. The method of claim 16, wherein the performing the process for the repayment of the debt to the failed bidders by the successful bidders comprises collecting information on the successful bidders, information on the failed bidders, and information on an amount of money to be repaid by the successful bidders for the failed bidders.

25. The method of claim 24, wherein the amount of money to be repaid by the successful bidders for the failed bidders is calculated on the basis of the bidding price.

26. The method of claim 24, wherein the performing the process for the repayment of the debt to the failed bidders by the successful bidders comprises collecting information on a method of the repayment to the failed bidders by the successful bidders.

27. The method of claim 26, wherein the information on the method of the repayment comprises at least one of a number of times of the repayment, a period required for the repayment, and a repayment means.

28. The method of claim 27, wherein the repayment means comprises at least one of cash, securities, and near money able to be used like cash under predetermined conditions.

29. The method of claim 24, wherein the performing the process for the repayment of the debt to the failed bidders by the successful bidders comprises requesting, on a basis of the collected information, execution of the repayment from a financial institution.

30. The method of claim 16, wherein the performing the process for the repayment of the debt to the failed bidders by the successful bidders comprises:
receiving, from the failed bidders, an application for donation of money to be refunded; and
performing a process for donating the money when the successful bidders repay the debt.

31. A non-transitory computer-readable recording medium for recording a program for performing, in a computer, a bidding service providing method according to claim 16.
